(19) United States
(12) Patent Application Publication
(10) Pub. No.: US 2009/0016683 A1
(43) Pub. Date: Jan. 15, 2009

(54) ANGLED FIBER FERRULE HAVING OFF-AXIS FIBER THROUGH-HOLE AND METHOD OF COUPLING AN OPTICAL FIBER AT AN OFF-AXIS ANGLE

(75) Inventors: Jun Zheng, Houston, TX (US); Chung-Yung Wang, Sugar Land, TX (US)

Correspondence Address: APPLIED OPTOELECTRONICS, INC., 13111 JESS PIRTLE BLVD., SUGAR LAND, TX, 77478, US

(73) Assignee: APPLIED OPTOELECTRONICS, INC., Sugar Land, TX (US)

(21) Appl. No.: 11/775,396

(22) Filed: Jul. 10, 2007

(51) Int. Cl. G02B 6/36; G02B 6/43

(52) U.S. Cl. 385/78

(57) ABSTRACT

An angle-polished optical fiber may be mounted relative to a laser at an off-axis angle to allow coupled light from a laser to be substantially aligned with the axis of the fiber core. An angled fiber ferrule may facilitate providing the off-axis angle when coupling the angle-polished optical fiber to a laser package. The angled fiber ferrule includes a through hole including at least a portion that is off-axis. The axis of the off-axis portion of the through hole is angled at the off-axis angle with respect to an axis of the ferrule body portion.

### TECHNICAL FIELD

The present invention relates to laser packaging and in particular, to coupling an optical fiber to a laser.

### BACKGROUND INFORMATION

The following descriptions and examples are not admitted to be prior art by virtue of their inclusion within this section.

Semiconductor lasers are used in a variety of applications, such as high-bit-rate optical fiber communications. To provide optical fiber communications, lasers are optically coupled to fibers to enable modulated light output from the laser to be transmitted into the fiber. Various modules, assemblies or packages are used to hold and align the laser, other optical components (e.g., collimation and coupling lenses, isolators, and the like), and optical fiber such that the laser is optically coupled to the fiber. The process of aligning an optical fiber to a laser diode and fixing it in place is sometimes referred to as fiber pigtailing. Standard laser package types include coaxial or TO (transistor outline) can laser packages and butterfly laser packages.

In a TO can laser package, for example, the laser (e.g., a laser diode) and the light-receiving end of the optical fiber may be mounted together within a substantially cylindrical housing. The laser may be mounted on a laser submount on the TO can post of the TO can header. The fiber end may be disposed in a rigid cylindrical ferrule mounted to the TO can housing. The TO can housing may also contain other related components, such as a lens and a monitor photodiode, and may be hermetically sealed.

In a butterfly type laser package, the laser and related components are mounted on a platform such as an optical bench within a metal boxlike housing that may be hermetically sealed. These related components may include laser circuitry including signal conditioning and impedance matching circuits, and a temperature sensor. The laser and laser circuitry are electrically connected to one or more pins extending laterally from the housing (e.g., 7 pins on each side). In one type of butterfly type housing, there is an opening in an end sidewall of the housing that receives a metal pipe or ferrule. The fiber is inserted through the ferrule into the inside of the housing and soldered to the ferrule for a sealed fit. Components such as an isolator and one or more lenses may be disposed on the platform between the laser and the input end of the fiber.

One problem that often arises when a laser is coupled to a fiber is back reflection from the end face of the fiber back into the laser cavity. One way to reduce back reflect is to use an angle-polished fiber, which has its end surface polished to a fiber end angle (e.g., 8°) slightly off of the plane normal to the axis of the fiber core. Light from the laser that reflects off of the fiber end, instead of being coupled into the fiber, is reflected at an angle with respect to the axis of the fiber and is thus not reflected back into the laser cavity. One drawback of this approach, however, is that coupling efficiency may be reduced, for example, from 70% to 50%. A primary reason for this reduction in coupling efficiency is that the angled fiber end causes light coupled into the fiber core at the angled end to be bent at a certain refraction angle due to the different indices of refraction of the fiber and surrounding medium (e.g., air). As a result, the light is coupled “off axis” and is not coupled into the fiber substantially parallel to the axis of the fiber core.

### BRIEF DESCRIPTION OF THE DRAWINGS

These and other features and advantages will be better understood by reading the following detailed description, taken together with the drawings wherein:

FIGS. 1A and 1B are side schematic views of an optical fiber illustrating the angles of incidence and refraction of the light being coupled into the fiber, consistent with embodiments of the present invention.

FIG. 2 is a side perspective view of an angled fiber ferrule, consistent with one embodiment of the present invention.

FIG. 3 is a side schematic view of a laser package housing coupled to an angled fiber ferrule, consistent with one embodiment of the present invention.

FIG. 4 is a side view of an angled fiber ferrule, consistent with another embodiment of the present invention.

FIG. 5 is a side view of an angled fiber ferrule including an on-axis through-hole portion and an off-axis through-hole portion, consistent with a further embodiment of the present invention.

FIG. 6 is a side view of an angled fiber ferrule, consistent with yet another embodiment of the present invention.

FIG. 7 is a partially cross-sectional side view of an optical fiber coupling including an angled fiber ferrule, consistent with a further embodiment of the present invention.

### DETAILED DESCRIPTION

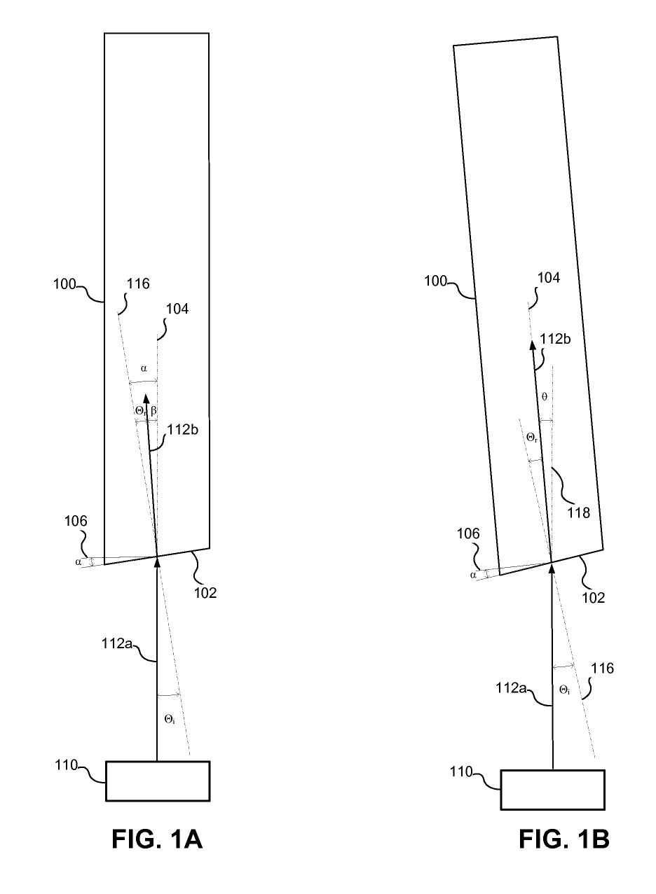

Referring to FIGS. 1A and 1B, an angle-polished optical fiber 100 may be coupled to a laser 110 at an off-axis angle θ to improve the coupling efficiency between the laser 110 and the optical fiber 100. The optical fiber 100 and laser 110 may be coupled, for example, in a laser package (not shown) such as a transistor outline (TO) can type laser package or a butterfly type laser package. Such laser packages may be used, for example, in optical transmitters to transmit optical signals through optical fibers.

The laser 110 emits light 112a directed to the optical fiber 100 and the emitted light 112a travels predominantly along a direction toward the optical fiber. At least a portion of the light 112a emitted from the laser 110 is coupled into the optical fiber 100, and at least a portion of the coupled light 112b then travels down the optical fiber 100. The angle-polished optical fiber 100 includes an end face 102 that is angled at a fiber end angle a relative to a plane 106 normal to an axis 104 of the fiber 100. The fiber end angle α generally prevents at least some of the emitted light 112a from the laser 110 from being reflected back from the end face 102 into a cavity of the laser 110.

As shown in FIG. 1A, however, the angled end face 102 results in an incidence angle Θᵢ of the emitted light 112a relative to a normal line 116 normal to the end face 102, which is the boundary between the medium of the fiber 100 and the surrounding medium around the fiber 100. In this configuration where the optical fiber 100 is on axis relative to the laser 110 and emitted light 112a (i.e., the axis of the fiber aligns with the direction of the emitted light), the incidence angle Θᵢ of the emitted light 112a is equal to the fiber end angle α. As a result of the difference in the indices of refraction between the medium of the fiber 100 (e.g. air) and the surrounding medium (e.g., air), the coupled light 112b enters the optical fiber 100 at a refraction angle Θᵢ relative to the normal line 116. As a result of the refraction, the coupled light 112b enters the optical fiber 100 at an angle β relative to the fiber axis 104 and thus may not be aligned with the fiber axis 104, which adversely affects the coupling efficiency.

As shown in FIG. 1B, the optical fiber 100 may be coupled to the laser 110 at an off-axis angle θ such that the coupled light 112b enters the optical fiber substantially aligned with the fiber axis 104. In the illustrated embodiment, the off-axis angle θ is the angle of the axis 104 of the fiber relative to an axis 118 aligned with the direction of the emitted light 112a (i.e., the predominant direction of the light emitted from laser 110). Angling the fiber at the off-axis angle θ correspondingly increases the incidence angle Θᵢ of the emitted light 112a sufficient for the coupled light 112b to refract at an increased refraction angle Θᵣ such that the coupled light 112a is substantially aligned with the fiber axis 104. The extent of the alignment may vary depending upon the desired coupling efficiency. For the coupled light 112b to be substantially aligned with the fiber axis 104 according to one embodiment, the refraction angle Θᵣ should generally correspond to the fiber end angle α. According to one embodiment, therefore, the off-axis angle θ may be determined according to the following equation:

$$θ \approx α ( \frac{{n}_{f}}{{n}_{a}} - 1 ) \qquad Eq . ( 1 )$$

wherein α is the fiber end angle, n_{f} is the index of refraction of the fiber, and nₐ is the index of refraction of the surrounding medium from which the light is coupled into the fiber.

Where the surrounding medium is air, the off-axis angle θ may be determined according to the following equation:

θ≈α(n_{f}−1) Eq. (2)

One example of an angle-polished optical fiber may have a fiber end angle α of about 8° and may be made of fused silica with an index of refraction n_{f} of about 1.47. According to this example, the off-axis angle θ may be about 3.7° to provide substantial alignment of the coupled light with the axis of the fiber core.

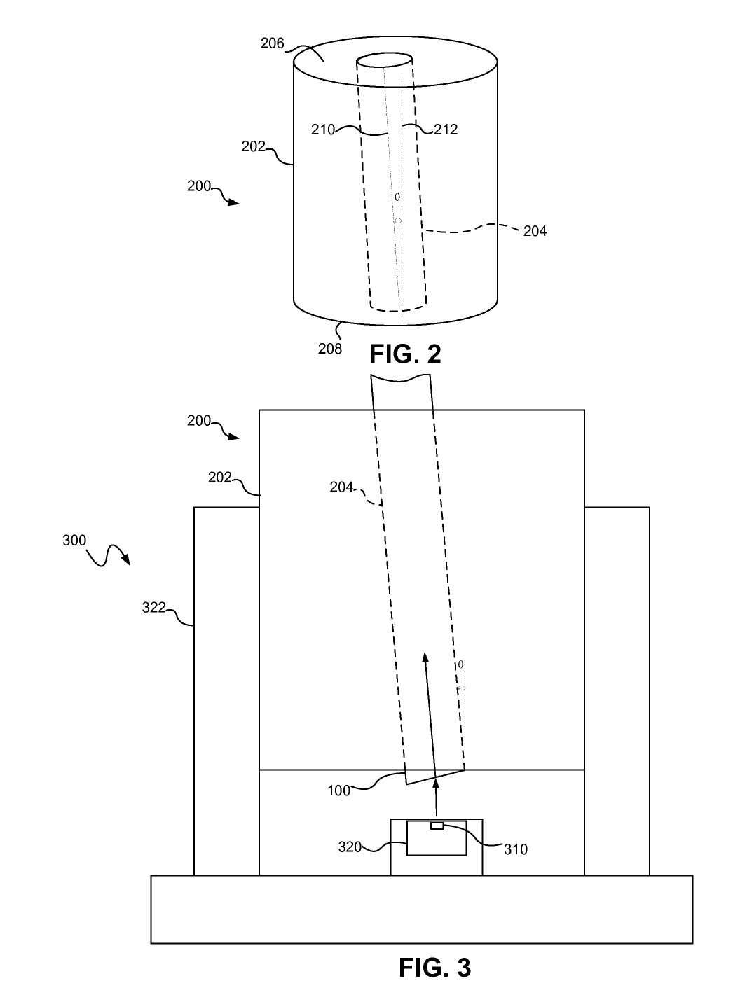

According to one embodiment, the angle-polished optical fiber 100 may be coupled to the laser 110 at the off-axis angle θ using an angled fiber ferrule 200, as shown in FIG. 2. The angled fiber ferrule 200 may include a ferrule body portion 202 with a through-hole 204 extending from a first end 206 to a second end 208 of the ferrule body portion 202. The through-hole 204 is configured to receive the fiber (not shown) such that the fiber ferrule 200 may be used to couple the fiber to a laser package (not shown). To provide the off-axis angle θ of the fiber in the angled fiber ferrule 200, the through-hole 204 includes at least a portion that is angled or off-axis. In other words, the axis 210 of at least a portion of the through-hole 204 is angled at the off-axis angle θ with respect to a ferrule axis 212. As used herein, therefore, “angled fiber ferrule” refers to a fiber ferrule in which at least a portion of the through-hole is angled or off-axis.

As shown in FIG. 3, the angled fiber ferrule 200 may be used to couple the angle-polished optical fiber 100 to a laser package housing 300, such as a TO can type laser package housing or a butterfly type laser package housing. A laser 310 may be mounted to a submount 320 inside the laser package housing 300. The laser package housing 300 may include a ferrule mounting portion 322 that provides an opening configured to receive the angled fiber ferrule 200. The angled fiber ferrule 200 may be aligned using known active and passive alignment techniques and may be mounted to the housing 300 by known techniques such as welding, soldering, or epoxy. One or more lenses or optics (not shown) may be positioned between the laser 310 and the end of the fiber 100.

In a TO can type laser package housing, for example, the ferrule mounting portion 322 may be a cylindrical portion extending from a TO header and having a lens disposed in a portion thereof. In a butterfly type laser package housing, the ferrule mounting portion 322 may be located in a sidewall of a boxlike housing and lenses or optics may be disposed on a platform between the laser and the end of the fiber.

The angled fiber ferrule 200 thus allows the optical fiber 100 to be passively and automatically angled relative to the laser 310 at the off-axis angle θ by mounting the ferrule 200 to the laser package housing 300, for example, using a conventional alignment and mounting process. In other words, using the angled fiber ferrule 200 may avoid the more difficult process of actively angling the laser and/or the ferrule-mounted fiber to achieve the off-axis angle θ.

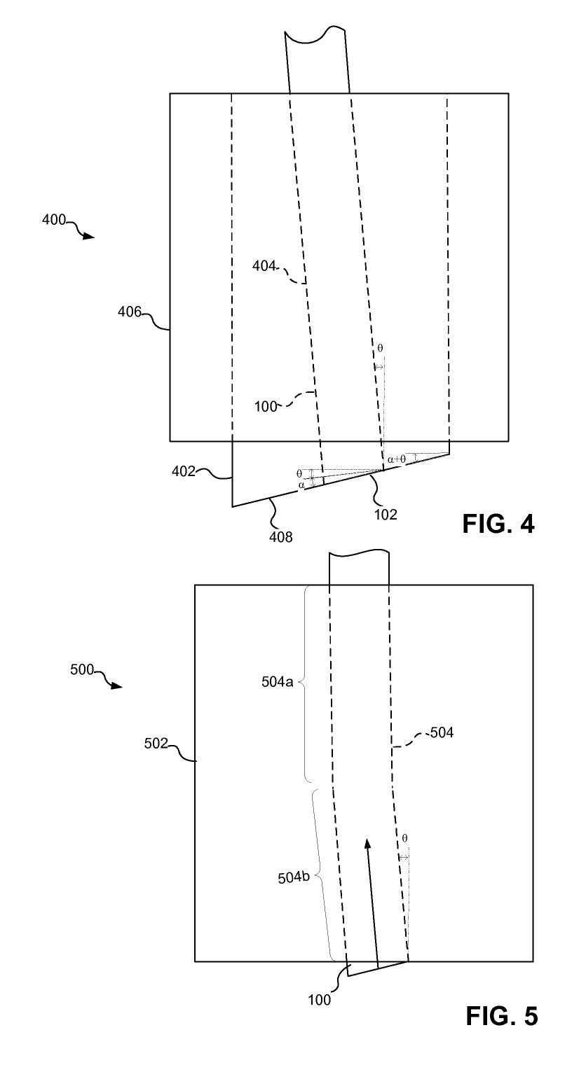

Referring to FIG. 4, another embodiment of an angled fiber ferrule 400 may include a ferrule body portion 402 with the off-axis through-hole 404 and an angled or non-orthogonal ferrule end face 408. The fiber 100 may be inserted into the through-hole 404 prior to polishing the end face 102 at the desired fiber end angle α. The end face 408 of the ferrule body portion 402 and the end face 102 of the fiber 100 may then be polished together to provide the desired fiber end angle α. Because the fiber 100 is angled at the off-axis angle θ relative to the axis of the ferrule body portion 402, the ferrule end face 408 is polished at a ferrule end angle α′ equal to the desired fiber end angle α plus the off-axis angle θ, which results in the desired fiber end angle α. For example, if the desired fiber end angle α is about 8° and the off-axis angle θ is about 3.7°, the ferrule end face 408 may be polished at a ferrule end angle α′ of about 11°.

In this embodiment, the ferrule body portion 402 may be an inner body portion located in an outer body portion 406. In one embodiment, the inner body portion 402 may be made of one material, such as a ceramic or glass, and the outer body portion 406 may be made of another material such as metal. One such angled fiber ferrule 400 is sometimes referred to as an angled polished connector (APC) ferrule. Although one type of APC ferrule is shown, other types of APC ferrules may be provided with an off-axis through-hole according to the concepts described herein.

Referring to FIG. 5, another embodiment of an angled fiber ferrule 500 may include a through-hole 504 having an on-axis portion 504a and an off-axis portion 504b. The off-axis portion 504b is angled at the off-axis angle θ such that the light at least enters the optical fiber 100 substantially aligned with the fiber axis. This type of through-hole 504 may also be provided in the inner ferrule body portion 402 of the ferrule 400 described above.

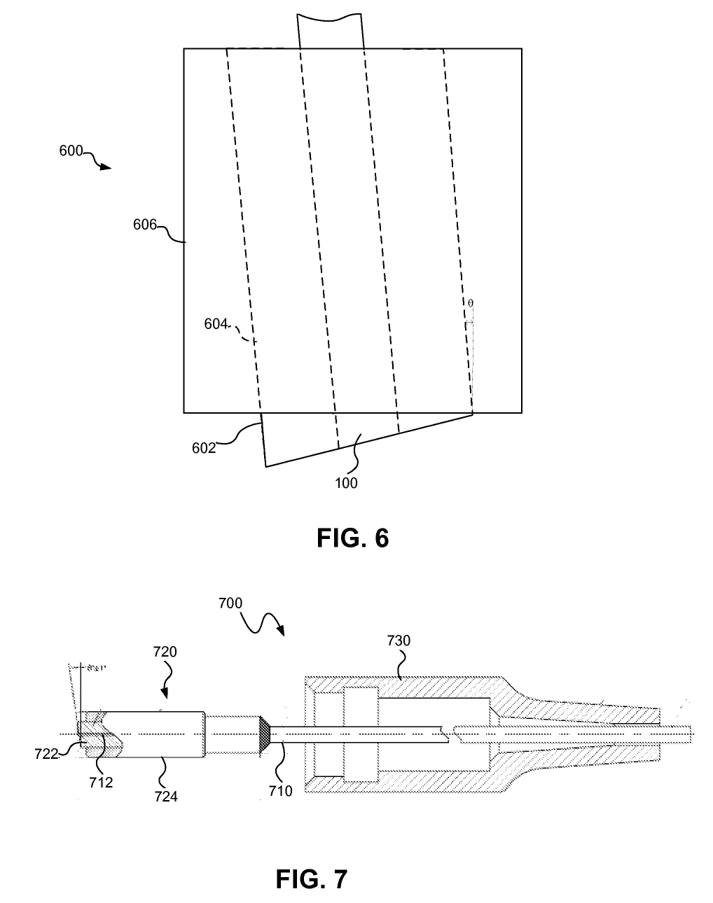

Referring to FIG. 6, a further embodiment of an angled fiber ferrule 600 may include an inner ferrule body portion 602 that is angled relative to an outer ferrule body portion 606 to provide the off-axis angle θ of the fiber 100. In this embodiment, the angled through-hole 604 is located within the outer ferrule body portion 606 and receives the inner ferrule body portion 602. The angled through-hole 604 is angled at the off-axis angle θ relative to an axis of the ferrule 600. The through-hole 608 within the inner ferrule portion 606 is thus on-axis relative to the inner ferrule body portion 602 but off-axis relative to the ferrule 600. In this embodiment, the inner ferrule body portion 602 may be angle polished similar to the ferrule body portion 402 shown in FIG. 4 and described above.

FIG. 7 shows a fiber coupling 700 (sometimes referred to as a pigtail coupling) consistent with a further embodiment. According to this embodiment, the fiber coupling 700 includes an optical fiber 710 coupled to an angled fiber ferrule 720. The optical fiber 710 may be secured to the angled fiber ferrule 720, for example, by soldering. The angled fiber ferrule 720 includes an inner ferrule body portion 722 and an outer ferrule body portion 724. The inner ferrule body portion 722 may be made of glass or ceramic and the outer ferrule body portion 724 may be made of metal. The inner ferrule body portion 722 includes a through-hole that receives a fiber core 712 of the optical fiber 710. The angled fiber ferrule 720 may provide the off-axis angle θ according to any of the embodiments described above. The fiber ferrule 720 may be coupled to a laser package, such as a TO can type laser package or a butterfly type laser package. A rubber boot 730 may be positioned over the ferrule 720 to provide strain relief.

Accordingly, the angled fiber ferrule consistent with embodiments of the present invention may facilitate alignment of coupled light from a laser with a fiber axis in an angle polished optical fiber to improve coupling efficiency.

Consistent with one embodiment, an angled fiber ferrule may be used with an optical fiber having an end face angled at a fiber end angle (α) with respect to a plane normal to an axis of the fiber. The angled fiber ferrule includes a ferrule body portion having a first end and a second end. The ferrule body portion defines a through-hole extending from the first end to the second end and configured to receive the optical fiber. At least a portion of the through-hole is off-axis such that an axis of the off-axis portion of the through-hole is angled at an off-axis angle (θ) with respect to a ferrule axis of the ferrule body portion.

Consistent with another embodiment, an optical fiber coupling includes an optical fiber having an end face angled at a fiber end angle (α) with respect to a plane normal to an axis of the fiber. The end face is configured to receive light coupled into the optical fiber. The optical fiber coupling also includes an angled fiber ferrule including a ferrule body portion having a first end and a second end. The ferrule body portion defines a through-hole extending from the first end to the second end and configured to receive the optical fiber. At least a portion of the through-hole is off-axis such that an axis of the off-axis portion of the through-hole is angled at an off-axis angle (θ) with respect to a ferrule axis of the ferrule body portion.

Consistent with a further embodiment, a laser package includes a laser package housing including a ferrule mounting portion and a laser mounted within the laser package housing. An angled fiber ferrule is configured to be mounted in the ferrule mounting portion of the laser package housing. The angled fiber ferrule includes a ferrule body portion having a first end and a second end. The ferrule body portion defines a through-hole extending from the first end to the second end and configured to receive the optical fiber. At least a portion of the through-hole is off-axis such that an axis of the off-axis portion of the through-hole is angled at an off-axis angle (θ) with respect to a ferrule axis of the ferrule body portion such that light from the laser is coupled into the optical fiber substantially aligned with an axis of the fiber.

Consistent with a yet another embodiment, a method of mounting an angle-polished optical fiber to a laser includes positioning the angle-polished optical fiber relative to the laser in an off-axis position such that an axis of the optical fiber is angled at an off-axis angle (θ) relative to a direction of emitted light being coupled into the fiber and securing the angle-polished optical fiber relative to the laser.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1. An angled fiber ferrule for use with an optical fiber having an end face angled at a fiber end angle (α) with respect to a plane normal to an axis of the fiber, the angled fiber ferrule comprising:
a ferrule body portion having a first end and a second end, the ferrule body portion defining a through-hole extending from the first end to the second end and configured to receive the optical fiber, at least a portion of the through-hole being off-axis such that an axis of the off-axis portion of the through-hole is angled at an off-axis angle (θ) with respect to a ferrule axis of the ferrule body portion.

2. The angled fiber ferrule of claim 1 wherein the off-axis angle (θ) is determined according to the equation
$$θ \approx α ( \frac{{n}_{f}}{{n}_{a}} - 1 ) ,$$
wherein α is the fiber end angle, n_{f} is the index of refraction of the fiber, and nₐ is the index of refraction of a medium from which the light is coupled into the fiber.

3. The angled fiber ferrule of claim 1 wherein the ferrule body portion is made of metal.

4. The angled fiber ferrule of claim 1 wherein the ferrule body portion is made of glass or ceramic.

5. The angled fiber ferrule of claim 1 wherein the ferrule body portion is substantially cylindrical.

6. The angled fiber ferrule of claim 1 wherein the ferrule body portion is configured to be coupled to a transistor outline (TO) can laser package housing.

7. The angled fiber ferrule of claim 1 wherein the ferrule body portion is configured to be coupled to a butterfly laser package housing.

8. The angled fiber ferrule of claim 1 wherein the ferrule body portion includes at least an inner portion of ceramic or glass and an outer portion of metal.

9. The angled fiber ferrule of claim 1 wherein the off-axis portion of the through hole extends from the first end to the second end.

10. The angled fiber ferrule of claim 1 wherein the through-hole includes an on-axis portion and an off-axis portion.

11. An optical fiber coupling comprising:
an optical fiber having an end face angled at a fiber end angle (α) with respect to a plane normal to an axis of the fiber, the end face being configured to receive light coupled into the optical fiber; and
an angled fiber ferrule including a ferrule body portion having a first end and a second end, the ferrule body portion defining a through-hole extending from the first end to the second end and configured to receive the optical fiber, at least a portion of the through-hole being off-axis such that an axis of the off-axis portion of the through-hole is angled at an off axis angle (θ) with respect to a ferrule axis of the ferrule body portion.

12. The optical fiber coupling of claim 11 wherein the off-axis angle (θ) provides a refraction of light coupled into the optical fiber such that light is coupled into the fiber refracts to a path substantially parallel to the axis of the fiber.

13. The optical fiber coupling of claim 11 wherein the off-axis angle (θ) is determined according to the equation
$$θ \approx α ( \frac{{n}_{f}}{{n}_{a}} - 1 ) ,$$
wherein α is the fiber end angle, n_{f} is the index of refraction of the fiber, and nₐ is the index of refraction of a medium from which the light is coupled into the fiber.

14. The optical fiber coupling of claim 11 wherein the off-axis portion of the through hole extends from the first end to the second end.

15. The optical fiber coupling of claim 11 wherein the through-hole includes an on-axis portion and an off-axis portion.

16. The optical fiber coupling of claim 11 wherein the ferrule body portion includes at least an inner portion and an outer portion.

17. A laser package for use with an optical fiber having an end face angled at a fiber end angle (α) with respect to a plane normal to an axis of the fiber, the laser package comprising:
a laser package housing including a ferrule mounting portion;
a laser mounted within the laser package housing; and
an angled fiber ferrule configured to be mounted in the ferrule mounting portion of the laser package housing, the angled fiber ferrule including a ferrule body portion having a first end and a second end, the ferrule body portion defining a through-hole extending from the first end to the second end and configured to receive the optical fiber, at least a portion of the through-hole being off-axis such that an axis of the off-axis portion of the through-hole is angled at an off-axis angle (θ) with respect to a ferrule axis of the ferrule body portion such that light from the laser is coupled into the optical fiber substantially aligned with an axis of the fiber.

18. The laser package of claim 17 wherein the off-axis angle (θ) is determined according to the equation
$$θ \approx α ( \frac{{n}_{f}}{{n}_{a}} - 1 ) ,$$
wherein α is the fiber end angle, n_{f} is the index of refraction of the fiber, and nₐ is the index of refraction of a medium from which the light is coupled into the fiber.

19. A method of mounting an angle-polished optical fiber to a laser, the angle-polished fiber having an end face angled at a fiber end angle (α) with respect to a plane normal to an axis of the fiber, the method comprising:
positioning a portion of the angle-polished optical fiber in a through-hole of an angled fiber ferrule, at least a portion of the through-hole being off-axis such that an axis of the off-axis portion of the through-hole is angled at the off-axis angle (θ) with respect to a ferrule axis of the angled fiber ferrule; and
mounting the angled fiber ferrule to a laser package, wherein the off-axis angle of the through hole causes the angle-polished optical fiber to be positioned relative to the laser in an off-axis position such that an axis of the optical fiber is angled at the off-axis angle (θ) relative to a direction of emitted light from the laser being coupled into the fiber.

20. The method of claim 19 wherein the off-axis angle (θ) provides a refraction of the light coupled into the optical fiber such that light is coupled into the fiber refracts to a path substantially parallel to the axis of the fiber.

21. The method of claim 19 wherein the off-axis angle (θ) is determined according to the equation
$$θ \approx α ( \frac{{n}_{f}}{{n}_{a}} - 1 ) ,$$
wherein α is the fiber end angle, n_{f} is the index of refraction of the fiber, and nₐ is the index of refraction of a medium from which the light is coupled into the fiber.

22-23. (canceled)
